(19) United States
(12) Patent Application Publication
(10) Pub. No.: US 2016/0331173 A1
(43) Pub. Date: Nov. 17, 2016

(54) COOKING TOOL HAVING EDGE OF ZIGZAG SHAPE, COOKING METHOD, AND FOODSTUFF

(71) Applicant: KABUSHIKI KAISYA LEBEN HANBAI, Yokohama-shi, Kanagawa (JP)

(72) Inventor: Atsushi TAKABU, Kanagawa (JP)

(73) Assignee: Kabushiki Kaisya Leben Hanbai, Yokohama-shi, Kanagawa (JP)

(21) Appl. No.: 14/894,851

(22) PCT Filed: Jun. 9, 2015
(86) PCT No.: PCT/JP2015/066605

§ 371 Date: Nov. 30, 2015

(30) Foreign Application Priority Data
May 13, 2015 (JP) 2015-002346U
May 14, 2015 (JP) 2015-002364U

(51) Int. Cl. A47J 17/02; B26B 9/02

(52) U.S. Cl. CPC A47J 17/02; B26B 9/02; A23L 1/0073; A23V 2002/00

(57) ABSTRACT

A cooking tool, which is easy to make a starting point for peeling, can perform peeling with a small force owing to a cutting edge arrangement for mainly slicing obliquely, and is safe owing to the cutting edge that hardly breaks. Further, a cooking method using the cooking tool and a foodstuff obtained by using the cooking tool are provided. The cooking tool of the invention has a cutting part provided with an edge of a zigzag shape. The edge is formed such that a bend angle of the zigzag shape is an obtuse angle and mountain lines as projected portions and valley lines as recessed portions are inclined to the direction of plate thickness and approximately parallel to one another. The pitch of the zigzag shape of the edge is more than or equal to 3 mm.

### TECHNICAL FIELD

The present invention relates to a cooking tool, a cooking method, and a foodstuff.

### BACKGROUND ART

A manually-operated peeler is known as a tool for stripping off skin of a vegetable or a fruit. Such a peeler has an edge of a shape that can strip off skin of an object only by moving it along the object. Thus, anyone can strip off skin easily and safely.

In many cases, a flat edge having a shape of flat plate is usually used as an edge of such a peeler. However, a flat edge of a flat-plate shape hardly catches on an object of cooking, and the edge may slip, making it difficult to make a starting point for peeling.

Thus, conventionally, an edge having a wave-shape or V-shapes is sometimes used (for example, Patent Literatures 1 and 2).

### CITATION LIST

### Patent Literature

Patent Literature 1: Utility Model Registration No., U.S. Pat. No. 3,195,081

Patent Literature 2: Utility Model Registration No., U.S. Pat. No. 3,180,909

### SUMMARY OF INVENTION

### Technical Problem

In the case where each foremost portion of such an edge has an acute V shape, the edge easily sticks in foodstuff. On the other hand, sticking always precedes, and it causes too heavy load on moving of the edge. Further, in the case where an edge has a curved shape, it is possible that the edge gets caught excessively and slides less smoothly on an object due to frictional resistance, or larger force is required in comparison with a flat edge, because, for example, the more area of the edge comes in contact with the foodstuff owing to its curvedness. Further, in the case of an edge having a projected foremost portion, there is, for example, a problem that the foremost portion brakes easily, when the foremost portion bites into hard foodstuff and is pulled in that state.

Thus, an object of the present invention is to provide a cooking tool that can easily make a starting point for peeling and can easily perform peeling with a small force because of a cutting edge arrangement for mainly slicing foodstuff obliquely, while making it possible to obtain thin slices giving good texture, and further that has foremost portions hard to break, therefore making the tool safer. Further objects of the present invention are to provide a cooking method using the mentioned cooking tool and to provide foodstuff obtained by using the cooking tool.

### Solution to Problem

To solve the above problems, the present invention provides a cooking tool that has a cutting part provided with an edge of a zigzag shape. The edge is formed such that a bend angle of the zigzag shape is an obtuse angle and mountain lines as projected portions and valley lines as recessed portions are inclined to the direction of the plate thickness and approximately parallel to one another. The pitch of the zigzag shape of the edge is more than or equal to 3 mm. The present invention includes a cooking method using the above-described cooking tool, and a foodstuff obtained by using the cooking tool.

Further, the present invention provides a foodstuff obtained by cutting to have a sheet-like shape in which a projected stripe and a recessed stripe appear alternately. The foodstuff is one of root vegetables, tubers, fruits, cucumber, tomato, cabbage, zucchini, uri (Oriental melon), niga-uri (balsam apple), celery, pumpkin, broccoli, cauliflower, cheese, fish, meat, and the like.

### Advantageous Effects of Invention

The present invention provides a cooking tool that is easy to make a starting point for peeling, can perform peeling with a small force owing to a cutting edge arrangement for mainly slicing obliquely, can obtain thin slices giving good texture, and is highly safe owing to the cutting edge that hardly breaks. Further, the present invention provides a cooking method using the cooking tool, and a foodstuff obtained by using the cooking tool.

### BRIEF DESCRIPTION OF DRAWINGS

FIGS. 1A, 1B, 1C, 1D, and 1E are respectively a plan view, a front view, a bottom view, a side view, and a back view of a cooking tool 10 according to a first embodiment of the present invention;

FIG. 2A is a front view of a blade member 11, FIG. 2B a reverse-side view of the blade member 11, and FIG. 2C an enlarged perspective view of an edge 113;

FIG. 3A is a partial enlarged perspective view of the blade member 11, and FIG. 3B a partial cross-section view of the blade member 11;

FIGS. 4A, 4B, 4C, 4D, and 4E are respectively a plan view, a front view, a bottom view, a side view, and a back view of a cooking tool 20 according to a second embodiment of the present invention;

FIG. 5 is a back view of the cooking tool 20;

FIGS. 6A, 6B, 6C, 6D, and 6E are respectively a plan view, a front view, a bottom view, a side view, and a back view of a cooking tool 30 according to a third embodiment of the present invention;

FIG. 7A is a front view of a blade member 31, and FIG. 7B a reverse-side view of the blade member 31;

FIG. 8 is a perspective view of a cooking tool 40;

FIG. 9A is a perspective view of a cooking tool 50, and FIG. 9B a perspective view of a cooking tool 60;

FIG. 10A is a cross-section view of a blade member 81, and FIG. 10B a partial enlarged view of an edge 813;

FIG. 11A is a back view of a cooking tool 70, FIG. 11B a partial enlarged view of a blade member 71, and FIG. 11C a partial cross-section view of the blade member 71;

FIGS. 12A and 12B are respectively a front view and a perspective view of a blade member 91 of a shape without a lower plate 114;

FIGS. 13A, 13B and 13C are front views of cooking tools having blade members 91a, 91b and 91c, respectively;

FIG. 14 is a partial enlarged view of an edge 913;

FIG. 15 is a perspective view of a cooking tool 100;

FIG. 16 is a perspective view of a cooking tool 110;

FIG. 17 is an explanatory view for explaining a cooking method to obtain a cut piece P from foodstuff F;

FIG. 18 is an enlarged view for explaining a cut surface S;

FIG. 19A is a cross-section view of a cut piece P obtained by cutting such that mountain lines and valley lines are each positioned above a line of the same kind, and FIG. 19B a cross-section view of a cut piece P obtained by cutting such that mountain lines and valley lines are each not positioned above a line of the same kind;

FIG. 20 is a perspective view of a cut piece P obtained by cutting such that mountain lines and valley lines cross;

FIG. 21 is an explanatory view for explaining a cooking method to obtain a short cut piece P; and

FIG. 22 is an explanatory view for explaining a cooking method to cut foodstuff F by rotating around the foodstuff F.

### DESCRIPTION OF EMBODIMENT

Embodiments of the present invention will be described referring to drawings in the following.

### First Embodiment

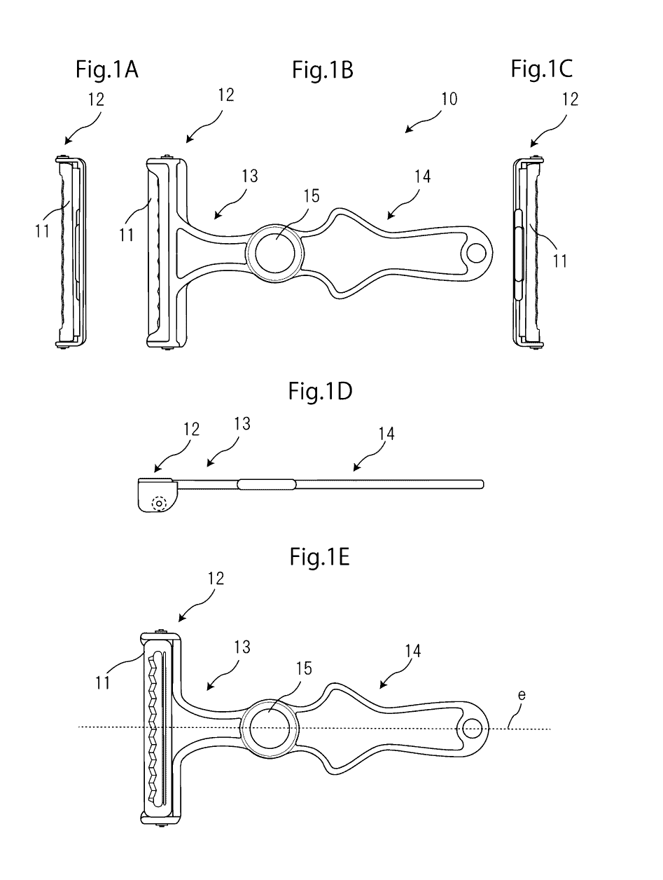

FIGS. 1A, 1B, 1C, 1D, and 1E are respectively a plan view, a front view, a bottom view, a side view, and a back view of a cooking tool 10 according to a first embodiment of the present invention.

As shown in FIG. 1A to FIG. 1E, the cooking tool 10 of one embodiment of the present invention comprises: a blade member 11; a head 12 (also called “cutting part”), which clamps and covers the blade member 11; a neck 13, which connects the head 12 and the below-stated gripping part 14; and the gripping part 14.

The blade member 11 is clamped swingably by the head at both ends in the longitudinal direction. Accordingly, the blade member 11 can turn by a prescribed turning angle in the head 12. This allows that an edge 113 of the blade member 13 is made to move along a surface shape of an object.

Further, as shown in the figure, the neck 13 and the gripping part 14 have a center line e in common, and the blade member 11 and the head 12 are provided such that their longitudinal directions are approximately perpendicular to the center line e (to form a T shape).

Further, between the neck 13 and the gripping part 14, there is provided a finger insertion hole 15 of a circular shape. A user places an index finger or the like in the finger insertion hole 15 and grasps the gripping part 14. By putting a finger through the finger insertion hole 15, it is possible to pull the whole cooking tool without slipping even if the gripping part 14 is grasped with weak force. At that time, since the neck 13 is formed of material having a certain level of flexibility, the neck 13 is bent when the user pushes the blade member 11 against the object. As a result, wasteful force is released at the neck 13, and uniform and beautiful peeled pieces can be obtained.

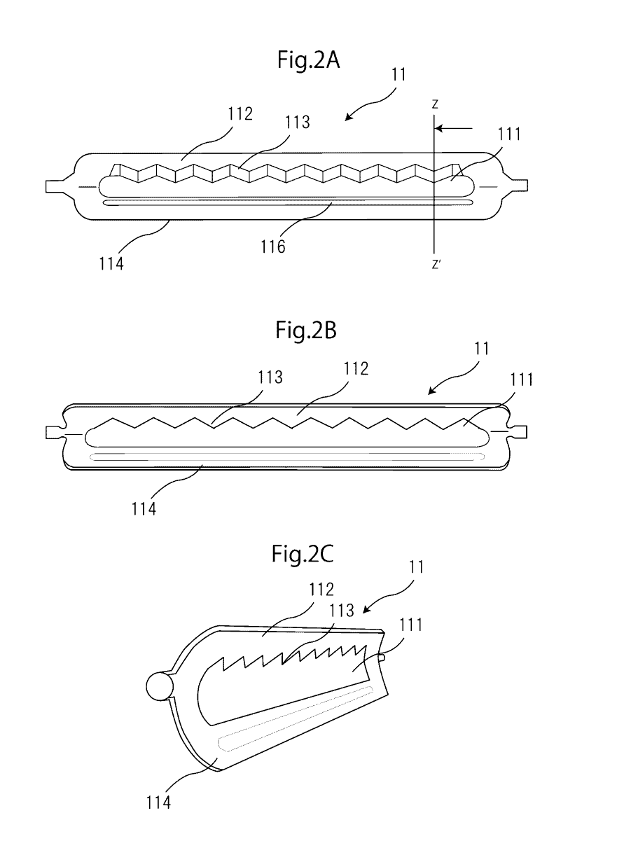

FIG. 2A is a front view of the blade member 11, FIG. 2B is a reverse-side view of the blade member 11, and FIG. 2C is a perspective view of the blade member 11. The blade member 11 is a curved plate-like member having an approximately rectangular shape seen from the front side or the reverse side and an approximately C shape seen from a side.

In the blade member 11, an escape hole 111 extending in the longitudinal direction is formed in the central part. In an upper plate 112, i.e. a surface provided above the escape hole 111, the edge 113 of a zigzag shape is formed on the side of the escape hole 111. Further, a lower plate 114, which is opposed to the upper plate 112 across the escape hole 111, is a part functioning as a guide at the time of cutting. The lower plate 114 is provided with a rib 116 extending in the longitudinal direction, to increase in strength. By providing such a guide, it is possible to stabilize movement of the edge 113 and to chip a piece uniformly from the object while the blade member 11 is put on the object and the head 12 is slid.

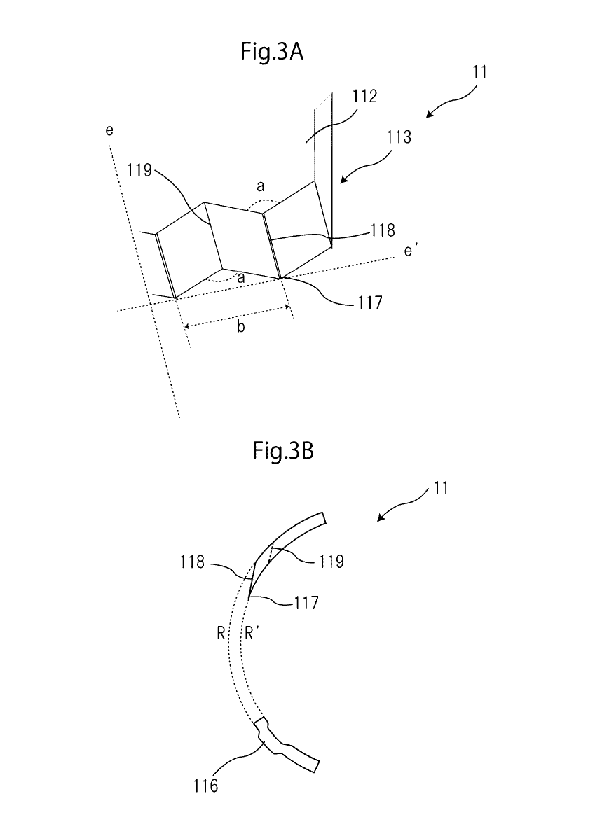

FIG. 3A is an enlarged perspective view of the blade member 11, and FIG. 3B is a cross-section view of the blade member 11 taken along the Z-Z′ line in FIG. 2B, being seen in the direction of the arrow.

The edge 113 is saw teeth of a zigzag shape, and its bend angle a is an obtuse angle more than or equal to 90 degrees, which is larger than a bend angle of an ordinary saw blade. In detail, the bend angle a is more than or equal to 90° and less than 175°, preferably more than or equal to 120° and less than 165°, and more preferably more than or equal to 140° and less than 160°. Owing to variation in processing, a foremost portion (a bottom portion of a V shape) 117 of the edge 113 sometimes becomes a slightly acute angle. However, the bend angle a is defined as an angle between tangent lines each nearly at a center position between a mountain portion and a valley portion. It is preferable that the angle at each foremost portion (the bottom portion of each V shape) 117 is not an acute angle but an obtuse angle.

In the case of a metal blade, the cutting edge may be quenched. If a foremost portion has an acute angle, the foremost portion easily bites into foodstuff, but on the other hand the foremost portion breaks easily in that case. The more obtuse the angle is as in the present embodiment, the more hardly the foremost portion bites into foodstuff, and the more hardly the foremost portion breaks. Accordingly, the blade member 11 is not limited to one made of metal, and may be made of ceramic.

Further, the pitch b, which is the distance between a mountain line 118 and an immediately adjacent mountain line 118 (or, between a valley line 119 and an immediately adjacent valley line 119) of the edge 113, is more than or equal to 3 mm and less than 30 mm, preferably more than or equal to 3 mm and less than 20 mm, and more preferably more than or equal to 3.5 mm and less than 12 mm.

Each mountain line 118 and each valley line 119 are respectively the highest portion of a projected portion and the lowest portion of a recessed portion, and each can be shaped to such a degree that it is easily seen as a line. That is to say, the edge 113 has such a shape that falls deeply from a mountain line 118 to an adjacent valley line 119 while keeping approximate flatness, changes its direction of inclination at the valley line 119, and rises again keeping approximate flatness up to a mountain line 118. Particularly, when a valley line 119 has a visually-identifiable shape, the bend angle a of the valley line 119 appears clearly without becoming round, and this affects the texture of foodstuff to be cut.

The edge width of the effective edge portion is more than or equal to 40 mm and less than 150 mm, preferably more than or equal to 50 mm and less than 120 mm, and more preferably more than or equal to 60 mm and less than 100 mm. The edge width and the above-mentioned teeth pitch of the teeth may be changed according to size, hardness and the like of foodstuff. For example, wider edge width is favorable for daikon (Japanese radish) in comparison with cucumber.

Here, a line e′ connecting the foremost portions 117 of the mountain lines 118 of the edge 113 is formed to be approximately perpendicular to the center line e of the gripping part 14 so that the gripping part 14 and the head 12 forms a T shape.

Further, as shown in FIG. 3B, each mountain line 118 as a projected portion and each valley line 119 as a recessed portion are inclined to the plate thickness direction, and are approximately parallel to one another. That is to say, the mountain lines 118 and the valley lines 119 are each formed to be oblique from the curved front surface R to the curved back surface R′ of the blade member 11. In other words, the mountain lines 118 and the valley lines 119 are inclined backward in the curved surface R by the thickness of the blade member 11, and the mountain lines 118 and the valley lines 119 are approximately parallel to one another.

Owing to the above-described formation of the edge 113, the edge 113 easily catches on the object with a cusp of a foremost portion 117 of the zigzag shape when the edge 113 is put into the object in cutting movement. Once the edge 113 catches on the object, the object can be cut with small force. Conventionally, there is a peeler provided with an edge of a zigzag shape whose foremost portion has an acute angle. Such a conventional peeler easily catches on an object, but afterward needs relatively large force for pulling the peeler due to larger frictional resistance. According to the peeler of the present embodiment, it is easy to make a starting point even in the case of a slippery smooth object. On the other hand, it is possible to perform peeling with small force in the case of an object poor in slippage. Further, since the zigzag shape suppresses side slipping, smooth catching-on and pulling are realized. Further, since the cutting edge from a mountain to a valley in the zigzag shape becomes inclined edge having a certain length, the peeler can perform slicing and a user can work safely with the peeler without putting his strength needlessly.

Further, since the edge 113 is provided in the curved member, it is possible to cut and release foodstuff smoothly in a circular motion. Further, in contrast with slim and deep corrugated cutting-edge marks made by the conventional acute angle saw teeth, non-congested and smooth marks remain on the cut surface. Accordingly, it is possible to obtain peeling pieces having beautiful cut surfaces and to obtain texture of root vegetables similar to those of leaf vegetables.

When, for example, root vegetable such as daikon (Japanese radish), carrot, or cucumber is cut by a cutting edge of the teeth pitch of 4 mm and cut pieces are put on a tongue, it is easy to feel the sensation of surface portions touching the tongue and surface portions not seated on the tongue resulting from the corrugated surface of the foodstuff, and accordingly it is possible to savor unprecedented texture of root vegetable. Further, it is possible to feel moderate crunchiness and firmness in the course of process where two or three portions of the corrugated surfaces of the foodstuff are put on upper portions of the teeth and biting force gradually increases from the projected surface to the whole foodstuff. Further, also when overlapped cut pieces of the foodstuff are bit, it is possible to obtain new texture of root vegetable somewhat similar to a conventional leaf vegetable.

Further, according to the cooking tool of the present embodiment, foodstuff is cut into a shape in which thinner portions and thicker portions appear as stripes depending on the shape of the edge 113. In particular, this is evident in the case of slicing foodstuff such as root vegetable in which cutting-edge marks easily remain. In such foodstuff, cutting-edge marks remain as a streamline pattern. Accordingly, when daikon or the like is cut, a cut piece has a sheet-like shape with stripes of stiff portions, and thus it is possible to give soft and yet crunchy texture. Further, owing to different thicknesses, the thin portions and the thick portions are different in degree of easiness of soaking of the flavor of sauce into the foodstuff. Thus, richer taste can be brought out from the foodstuff by cooking.

Further, it is possible to obtain a variety of texture depending on foodstuffs. For example, when a yam (Japanese yam) is cut, there is obtained a mixture of crumbling mushy portions and portions of remained shapes as those obtained by cutting into thin strips or slicing. In other words, there is obtained a cut product such as one obtained by performing a grating process and a cut process at the same time. When only the grating process is used, shape of cut object is completely lost. Thus when yam is eaten together with noodles, yam remains in soup until last, causing much of yam to result in a leftover. On the other hand, according to the cooking tool of the present embodiment, processed yam has portions whose shapes are lost and portions whose shapes remain as those obtained by cutting into thin strips (or by slicing). Thus, it is easy to eat yam together with noodles dressed with yam, and it is possible to eat yam in the way that yam hardly remains in soup. Further, conventionally, it is difficult to make tempura of yam. However, foodstuff processed by the cooking tool of the present embodiment has stiff portions giving crunchy texture, and thus it is possible to cook the foodstuff in the way suitable for making fried food such as tempura.

Moreover, each peeling operation makes cutting-edge marks shifted from the previous marks. Accordingly, when the cooking tool is pulled in the direction different from the cutting direction in the previous peeling operation, for example in the direction perpendicular to the previous cutting direction, cut pieces having crossed cutting-edge marks are obtained. As a result, cut pattern of foodstuff is changed, and this produces new texture. Further, when such cut foodstuff is eaten as pickles or after parboiling, new texture and taste are caused owing to the variation in thickness, and thus search for creation of new menu is stimulated. Further, owing to cutting-edge marks having shapes like those of mild waves, foodstuff is easily dressed with dressing or vinegar, and root vegetable can be made to have taste like that of pickles in a short time.

Vegetable cells are covered with semitransparent membrane, and thus sometimes vegetable is cooked by rubbing salt or preserved in salt in order to salinize it over time. In this regard, according to the present cooking tool, since slicing is performed by the present cooking tool, much water emerges in the course of cutting of, for example, daikon. This is because the cell membrane on the surface of vegetable is cut when the cells of the vegetable are sliced and cut. Accordingly, taste of salted vegetable can be obtained in a short time. It is considered as the result of slicing the lipid bilayers of a large number of cells at once.

Further, by changing the cutting pressure, it is possible to change variously thickness of cut foodstuff. For example, in the case of daikon, the difference in resultant thickness is about 2.5 times between cutting daikon by the minimum force and cutting by pressing against it at pressure of about 700 g. In comparison with the conventional blade having a flat cutting edge, the cooking tool of the present embodiment can produce greater variation in thickness since each foremost portion of the edge bites deeply into foodstuff by a pressing force and thereafter cuts the foodstuff. By changing thickness variously in this way, it is possible to taste several types of texture.

Further, by adjusting the pitch to become larger, reflection on the surface of the cut foodstuff becomes clear, increasing the luster. For example, in the case of slicing of daikon, contrast is strengthened also when dressing or the like is used. Further, even a small amount of dressing looks rich, leading to reduced salt and reduction of body weight. On the other hand, in the case of the conventional jagged edge having fine saw teeth, sometimes it is difficult to feel the quantity of foodstuff. Further, in the case of flat edge, soaking of dressing is poor, and liquid dressing runs off the surface of the foodstuff, and it is considered that the effect of appealing to eye is small.

### Second Embodiment

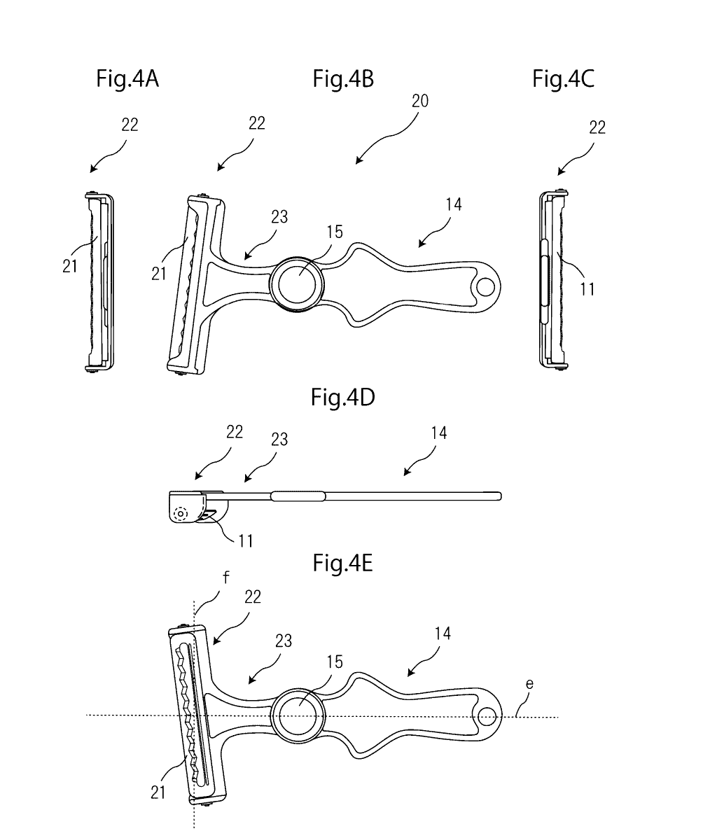

Next, a second embodiment of the present invention will be described. FIGS. 4A, 4B, 4C, and 4E are respectively a plan view, a front view, a bottom view, a side view, and a back view of a cooking tool 20 according to the second embodiment of the present invention. The cooking tool 20 of the present embodiment is different from the above embodiment in that a neck 23 gives inclination to a blade member 21 and a head 22 in relation to a gripping part 14. Here, components similar to those of the above embodiment are denoted by the same reference numbers, and their detailed description will be omitted.

The cooking tool 20 is provided with the blade member 21 and the head 22 such that the blade member 21 and the head 22 is inclined to a perpendicular line f perpendicular to a center line e in the almost same plane. Here, assuming a right-handed user, the blade member 21 and the head 22 are formed to be inclined rightward in the longitudinal direction, seen from the side of the head 22 (FIG. 4A). However, it is sufficient that the blade member 21 and the head 22 are at least inclined in one direction, and may be inclined toward the opposite side for a left-handed user.

FIG. 4 includes the back view of the cooking tool 20. As shown in the figure, the blade member 21 and the head 22 have an inclination c more than or equal to 3° and less than 40° with respect to the perpendicular line f to the center line e, preferably more than or equal to 5° and less than 35°, and more preferably more than or equal to 8° and less than 25°.

Further, in the edge 213 of the blade member 21, inclinations d1 and d2 of the edge are more than or equal to 0° and less than 30° with respect to the perpendicular line f, preferably more than or equal to 5° and less than 25°, and more preferably more than or equal to 8° and less than 20°. Here, the inclinations d1 and d2 of the edge does not need to be the same value.

Mountain lines 218 and valley lines 219 of the edge 213 are formed to be approximately parallel to the center line 3 of the gripping part 14. Also the bend angle a and the pitch b are similar to those in the first embodiment.

In the cooking tool 20, owing to the blade member 21 and the head 22 both inclined as described above, there is formed an inclination of the peeling direction from the direction of the arm of the user, and accordingly peeled skin and the like can fall bypassing the gripping part 14 and the area around the hand of the user.

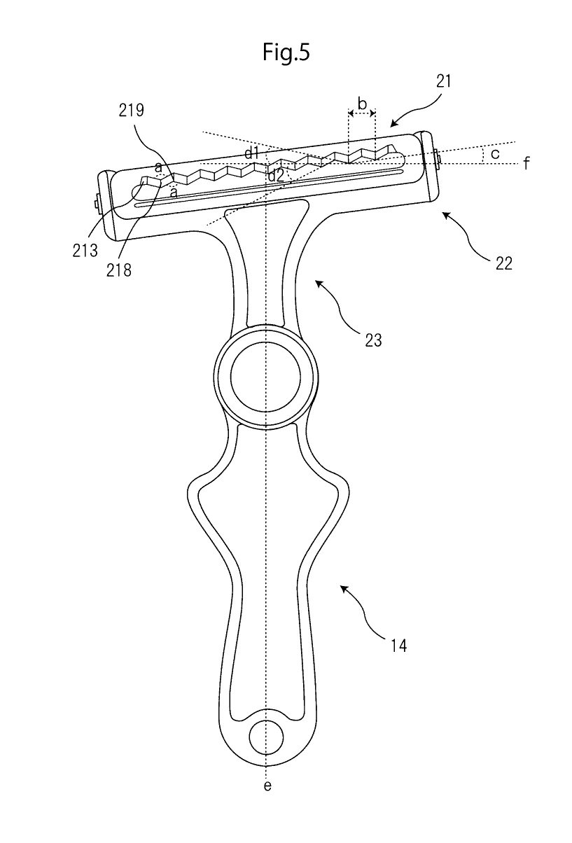

Since the blade member 21 is inclined, first cutting of foodstuff occurs not in the whole edge 213 but at a portion of the edge 213 on the side near to the gripping part 14 (in FIG. 5, the end portion on the left side of the viewer), and then gradually the whole of the edge 213 cuts the foodstuff. Accordingly, to cut foodstuff, the cooking tool 20 can be pulled by a small force initially. At the time when the whole edge 213 cuts foodstuff, peeling movement gains momentum, and thus the user can continue pulling the cooking tool 20 without feeling resistance.

### Third Embodiment

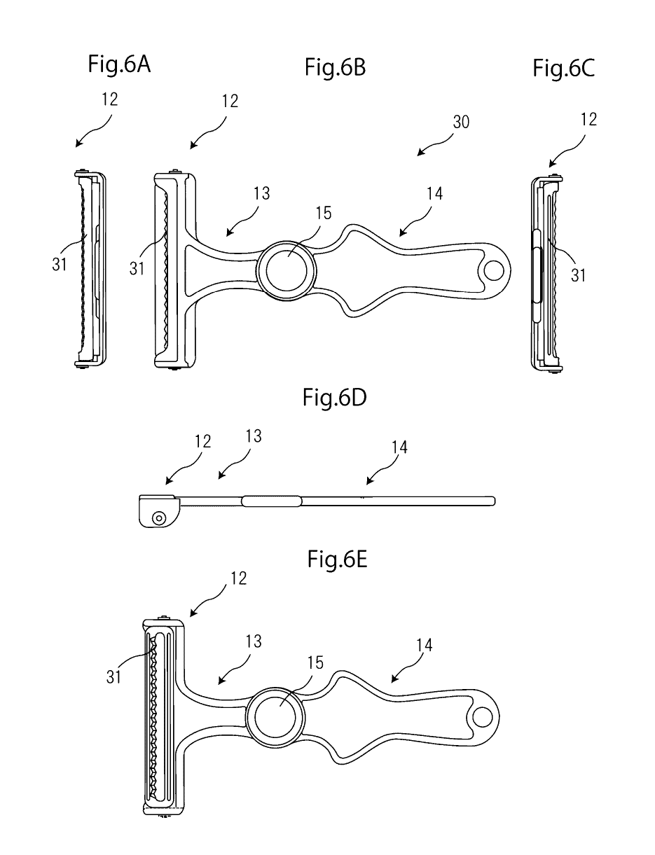

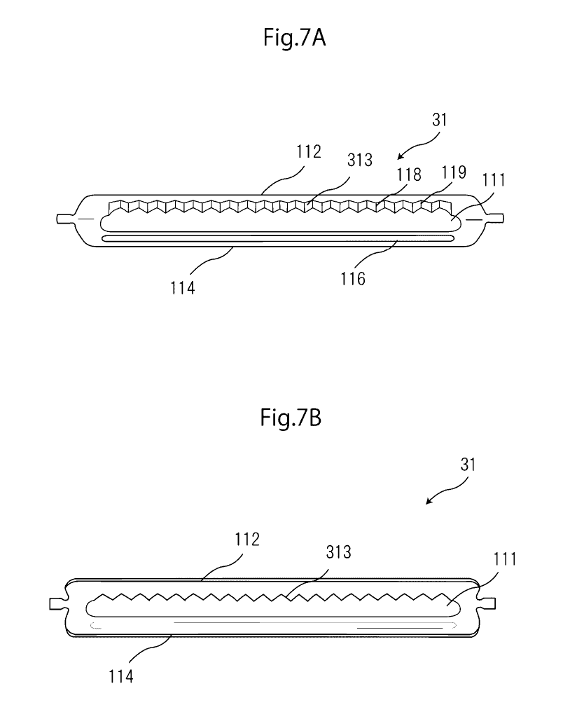

Next, a third embodiment of the present invention will be described. FIGS. 6A, 6B, 6C, 6D, and 6E are respectively a plan view, a front view, a bottom view, a side view, and a back view of a cooking tool 30 according to the third embodiment of the present invention. FIG. 7A is a front view of a blade member 31 of the cooking tool 30, and FIG. 7B is a reverse-side view of the blade member 31. The cooking tool 30 of the present embodiment is different from the first embodiment in that the pitch b of the edge 313 of the blade member 31 is shorter.

As shown in the figures, the blade member 31 of the cooking tool 30 of the present embodiment has the edge 313 of a shorter pitch b. In detail, the pitch b, which is the distance between a mountain line 118 and an immediately adjacent mountain line 118 (or, between a valley line 119 and an immediately adjacent valley line 119) of the edge 313, is more than or equal to 2 mm and less than 10 mm, preferably more than or equal to 2.5 mm and less than 6 mm, and more preferably more than or equal to 3 mm and less than 5 mm.

Owing to the above-described fine saw teeth, it is possible to obtain cut pieces having different cutting-edge marks from those of the above-described embodiments.

Hereinabove the embodiments of the present invention have been described. The above-described embodiments are intended to show the gist of the present invention by examples and not to limit the present invention. Various changes can be made within the scope of the present invention.

For example, each blade member can be transferred to cooking tools of shapes other than the above-described shapes.

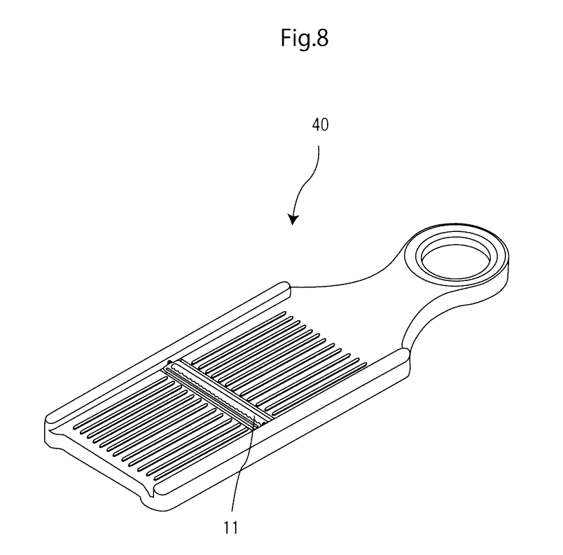

FIG. 8 is a diagram showing an example where the blade member 11 is used in a plate-like cooking tool 40. The cooking tool 40 is a slicer-type cooking tool that can perform cutting by the blade member 11 when foodstuff is slid back and forth on a stationary plate-like slide base. Here, by changing the direction of the installed blade member 11, it is possible to select the direction of sliding foodstuff. Here also, the blade member 11 can be mounted obliquely (i.e. being inclined to the direction perpendicular to the sliding direction of the foodstuff), and further a plurality of blade members 11 can be installed. For example, the blade member 11 may be positioned to be inclined at an angle more than or equal to 10 degrees and less than 30 degrees with respect to the direction perpendicular to the sliding direction of foodstuff.

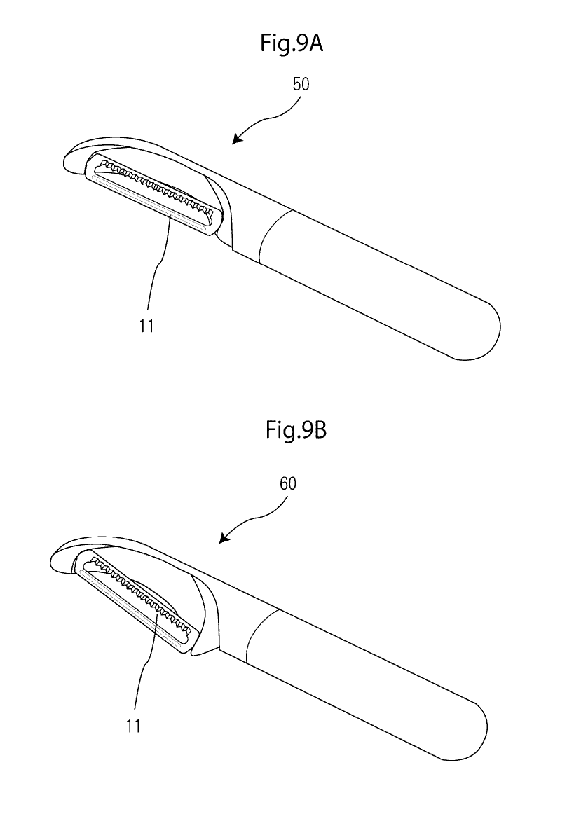

FIG. 9A is a diagram showing an example where the blade member 11 is used in an I-shaped cooking tool 50. In such an example, a user can obtain peeled pieces similar to those in the above embodiments by carrying out peeling operation, i.e. by sliding the cooking tool 50 back and forth or right and left.

Further, as shown in FIG. 9B, a cooking tool 60 may be formed so that the blade member 11 is inclined to the I-shaped main body. In this example, a user does not need to press the cooking tool 60 perpendicularly to a surface to cut, and can form a suitable angle to the surface to cut. Accordingly, it is easy to apply force particularly for pushing forward the cooking tool 60, and peeling operation can be performed easily.

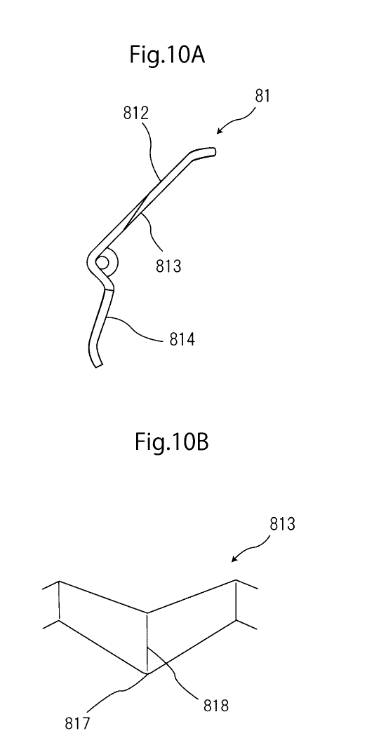

Further, also the shape of each blade member is not limited to those in the above embodiments. For example, FIG. 10A is a diagram showing a blade member 81, which is a plate-like member different from the blade members of the above embodiments. The blade member 81 has a large difference in level formed between an upper plate 812 and a lower plate 814, and its cross-sectional surface has approximately an S-shape. In the present example, the upper plate 812 is approximately planar, and the edge 813 is formed by cutting in an oblique direction from the surface to the back surface. This edge is adjusted by the angle of a cutting device (for example, whetstone), and the acuter the cutting device is the acuter the tip angle of the edge device becomes.

Further, as shown in FIG. 10B, the foremost portion 817 of each mountain line 818 may have a roundish shape. Such an edge 813 can be used safely because it hardly sticks in when touched. In detail, in the case of an object having a hard and elastic surface such as skin of hand or rubber, a crack tends to occur from a point in which a sharp foremost portion sticks. However, in the case of the roundish foremost portion 817 of the present embodiment, an object receives pressure in the whole area because of its elasticity, and thus a crack hardly occurs and skin is rarely cut.

Here, the curvature radius of the foremost portion 817 is more than or equal to 0.1 mm and less than 1 mm, preferably more than or equal to 0.2 mm and less than 0.8 mm, and more preferably more than or equal to 0.2 mm and less than 0.5 mm. Since the larger the pitch b of the saw teeth is, the longer and wider the inclined part from a mountain line to a valley line is, and thus the roundness of the foremost portion 817 hardly affects the performance of cutting foodstuff. Further, by providing the cutting edge to the curved member as in the above-described embodiment, processing of rounding the foremost portion 817 becomes easier.

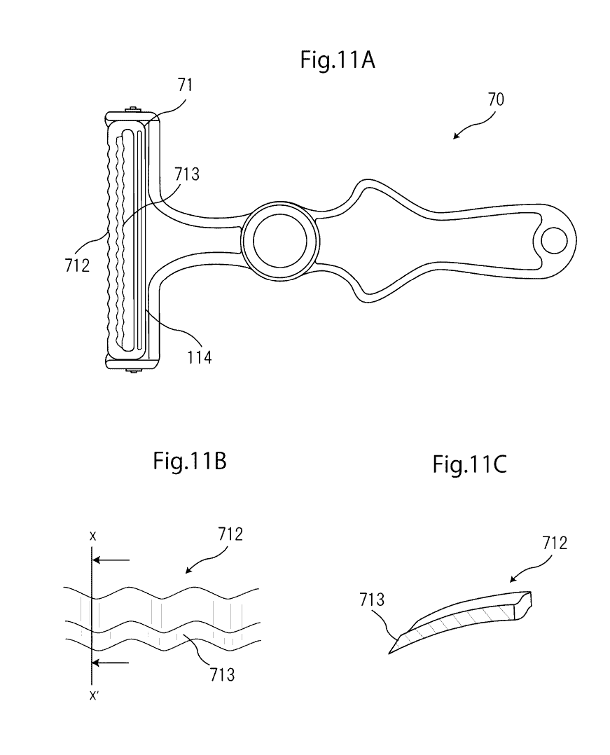

FIG. 11A is a diagram showing an example of a cooking tool 70 having a blade member 71 in which an upper plate 712 is not a flat plate but a corrugated plate formed into a wave shape in the plate-thickness direction. The cooking tool 70 is provided with a corrugated edge 713 instead of the above-mentioned edge 113. FIG. 11B is a partial enlarged view of the upper plate 712, and FIG. 11C is an X-X′ cross-section view of the upper plate 712 seen from the direction of the arrows. As shown in the figures, the upper plate 712 is mildly curved in the thickness direction, and corrugated in the longitudinal direction. Further, one side is much more inclined in the thickness direction, to form the edge 713. The bend angle and the pitch at the foremost portions of the corrugated edge 713 are similar to those of the above-described edge 11. According to the blade member 71 of the above-described construction, much greater unevenness is provided to the surface of cut foodstuff owing to the corrugation of the edge, and thus further variety of texture can be enjoyed.

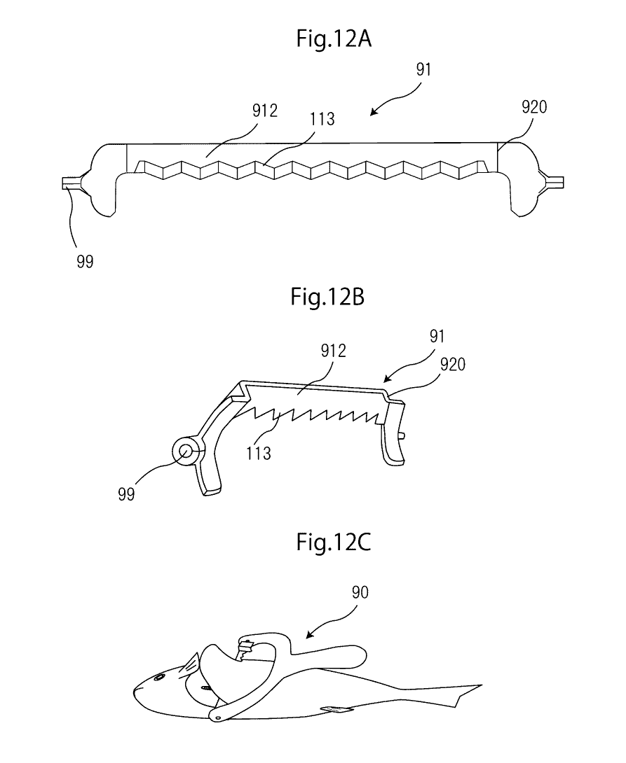

FIGS. 12A and 12B are respectively a front view and a perspective view of a blade member 91 of a shape without the lower plate 114. The blade member 91 has an upper plate 912, which is protruded forward due to steps 920. As a result, an edge 113 is positioned anteriorly to the head, and thus it is possible to make only the edge 113 come in contact with an object's surface to cut. Accordingly, even if a surface to cut is wider than the distance between clamping portions 99, uniform and deep cut is possible, and the object can be cut successively from an end. As shown in FIG. 12C, a cooking tool 90 having the described blade member 91 can be used for filleting a fish (such as jack mackerel or sardine) and for scraping away caudal fulcrum of a fish.

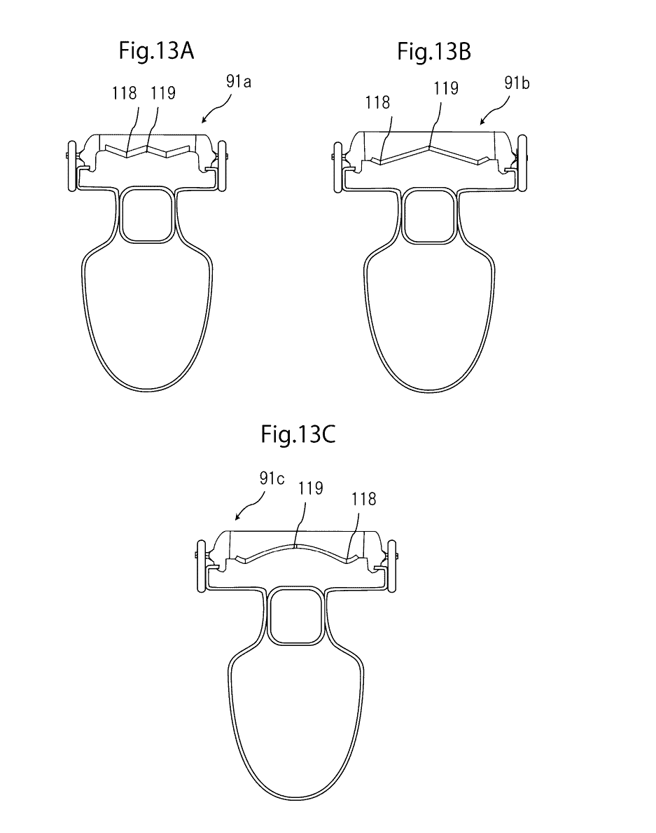

Further, as shown in FIG. 13A, a blade member 91a may be formed into a shape having two mountain lines 118 and three valley lines 119 at both outer sides of the mountain lines 118 and approximately in the center of the mountain lines 118. Further, as shown in FIG. 13B, a blade member 91b may be formed into a shape having two mountain lines 118 and one valley line 119 approximately in the center. Further, as shown in FIG. 13C, a blade member 19c may be formed into such a shape as obtained by somewhat rounding cusps of the projections and the recess of the edge of the blade member 91b. Such a blade member is suitable also for work of removing scales and fins of a fish and detailed work of removing skin and calyx of a fruit.

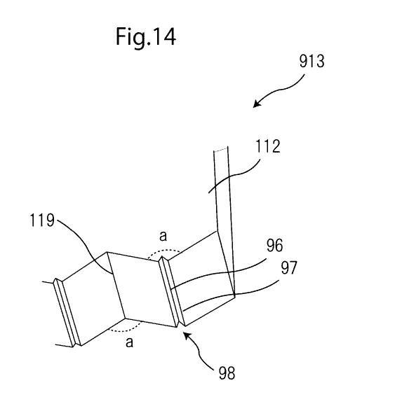

Further, as shown in FIG. 14, an edge 913 may be provided with an even smaller jagging 98 for catching foodstuff (i.e. for making a starting point for cutting foodstuff). Each jagging 98 comprises one valley portion 96, which is formed by grooving the portion corresponding to a mountain line 118, and two mountain portion 97 on both sides of the valley portion 96. The distance between both mountain portions 97 is preferably more than or equal to 0.5 mm and less than 1.5 mm. Further, each of the foremost portions of the two mountain portions 97 can be an acute angle (for example, more than or equal to 20 degrees and less than 90 degrees). Also the valley portion 96 can be an acute angle (for example, more than or equal to 20 degrees and less than 90 degrees). Owing to such a jagging 98, it is easy to form a starting point for cutting for not only a hard object but also soft cheese, squid, eggplant, or the like, thus making it easy to start cutting.

In the case of an edge having such a small jagging, all the mountain line portions may be each provided with a jagging, or some of mountain line portions may be each provided with a jagging. For example, a jagging may be provided at intervals of prescribed number of mountain line portions (for example, to every other, every third, or every fourth mountain line portion). Or, only mountain line portions in the neighbor of the center may be each provided with a jagging.

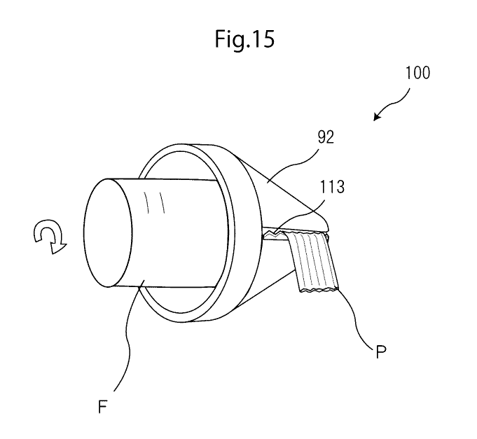

Further, each of the above-described edge may be used in a cooking tool having another shape (for example, a pencil sharpener type cooking tool or a spiral cutter, which are described in the following). FIG. 15 is a perspective view showing a cooking tool 100 that scrapes foodstuff by inserting the foodstuff into the inside of a tube as in a pencil sharpener. The cooking tool 100 has a head (a cutting part) 92 of a conical shape, and an edge 113 is provided in the side surface of the head 92. The tubular head 92 is opened on the bottom surface side. By pressing in foodstuff F from the opening and rotating the foodstuff F, the foodstuff F is rubbed in the inside and cut by the edge 113, so that a cut piece P is obtained. Thus, by inserting and rotating the foodstuff F, it is possible to perform safe and easy cutting without touching the edge 113.

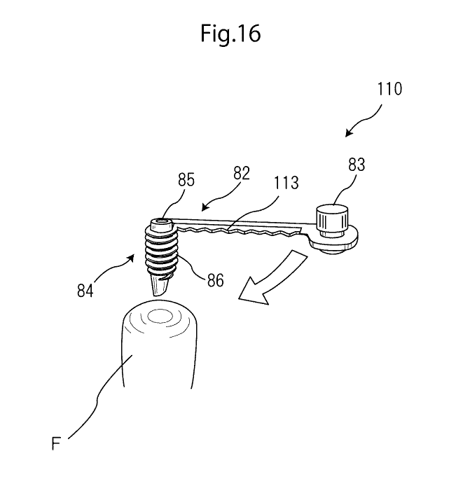

FIG. 16 is a perspective view showing a spiral cutter type cooking tool 110, which spirally cuts foodstuff of a cylindrical shape. The cooking tool 110 comprises: a drill part 84 provided circumferentially with a male screw 86; a cutting part 82 extending outwardly from the drill part 84; and a rotation knob 83 provided at the end of the cutting part 82. The cutting part 82 is provided with an edge 113 facing in the rotational direction. When the end of the drill part 84 of this cooking tool 110 is put on the foodstuff F and the rotation knob 83 is rotated in the rotational direction, the drill part 84 is screwed into the foodstuff F. At the same time, the edge 113 cuts the foodstuff F into a spiral shape. The drill part 84 may be provided with a through hole 85 at the center. In that case, it is possible to remove the core of carrot or the like at the same time.

### [Cooking Method of Foodstuff]

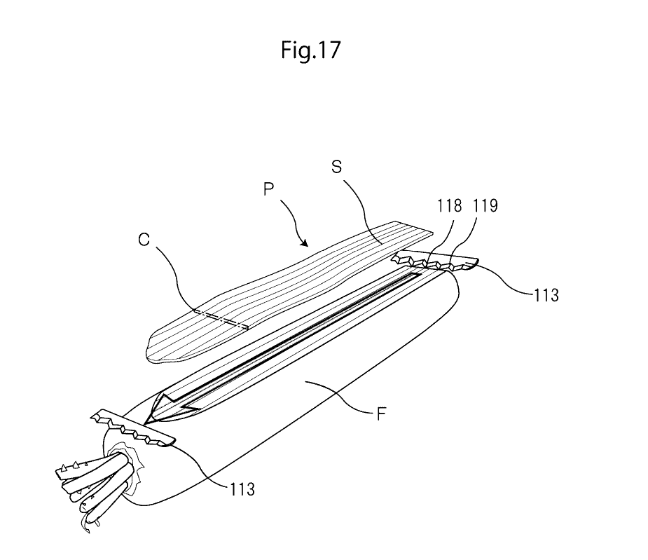

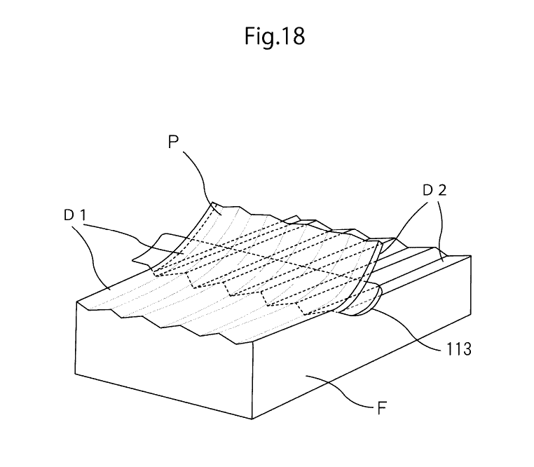

Next, will be described a cooking method using a cooking tool described in the above embodiments. FIG. 17 is a general view for explaining a method of cooking a foodstuff F, and FIG. 18 is an enlarged view for explaining the cooking method.

FIG. 17 is an explanatory view for explaining a cooking method in which the edge 113 is used to cut a foodstuff F (here, daikon is taken as an example, although any foodstuff F can be cut if that foodstuff F can be peeled since it is, for example, in a lump state) to obtain a sheet-like cut piece P. As shown in the figure, when the surface of the foodstuff F is repeatedly cut from end to end by the edge 113, cut pieces P are obtained with each piece P having an edge pattern on each of the front and back sides. In detail, as shown in FIG. 18, by cutting again the foodstuff F with a remaining edge pattern D1 due to the previous cutting in the front surface, there is formed a cut piece P having an edge pattern D2 due to the cutting of this time in the back surface. As a result, it is possible to obtain the cut piece P having respective edge patterns in both front and back surfaces.

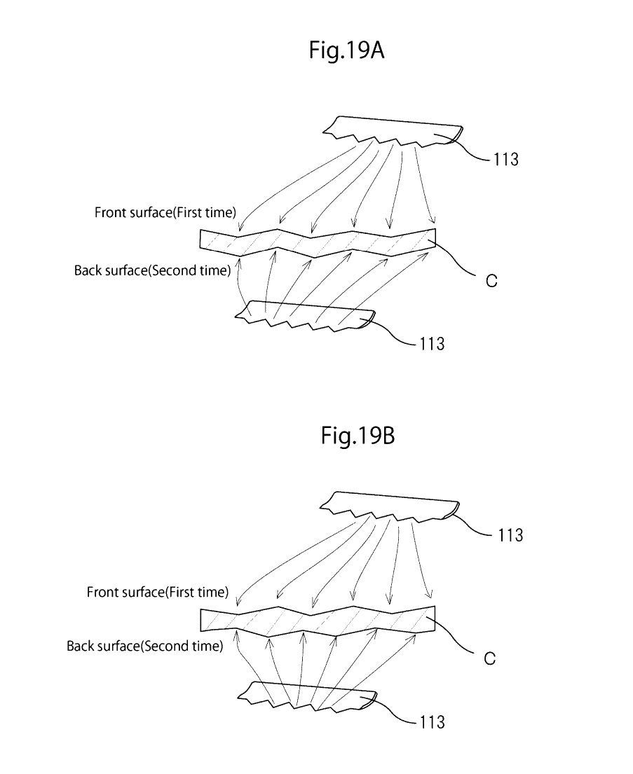

Each edge pattern of such a cut piece P is formed mainly by the mountain lines 118 and the valley lines 119 of the edge. In detail, a stripe mark in which a recessed stripe and a projected stripe are alternately formed is engraved as streamlines in a cut surface S. Accordingly, the shape of the cut piece P changes depending on the locus of the edge 113. FIGS. 19A and 19B are diagrams showing examples of cross-sectional surface C of the cut piece P of FIG. 17. Here, for the sake of convenience, the upper side of the cut piece P is referred to as the front surface, and the underside as the back surface.

In the cut piece P shown in FIG. 19A, an edge pattern engraved by first cutting is formed in the front surface, and an edge pattern engraved by second cutting in the back surface. The cut piece P in question is shown in a cross-section view in the case where the loci of the mountain lines 118 and the valley lines 119 of the edge 113 in the front and back surfaces approximately overlap with corresponding lines in the other surface. If, as shown in the figure, the edge 113 moves along the same path both in the first cutting and in the second cutting without sifting right or left (i.e. in the traverse direction), a cut piece P having a zigzag cross-section C whose thickness is approximately same at any position is obtained. Such a cut piece P can give texture similar to those of a leaf vegetable even in the case of a root vegetable.

FIG. 19B is a cross-section view showing a cut piece in the case where the mountain lines 118 and the valley lines 119 of the edge 113 are shifted right or left (in the traverse direction) between the first cutting and the second cutting. If, as shown in the figure, the edge 113 moves along paths shifted right or left (in the traverse direction) between the first cutting and the second cutting, a cut piece P having a cross-section C whose thickness is different depending on positions is obtained. Here, in the case where the mountain lines 118 in the first cutting approximately overlap with the valley lines 119 in the second cutting, a thick portion and a thin portion are repeated alternately in an obtained cut piece P, and the cut piece P can give a firm texture.

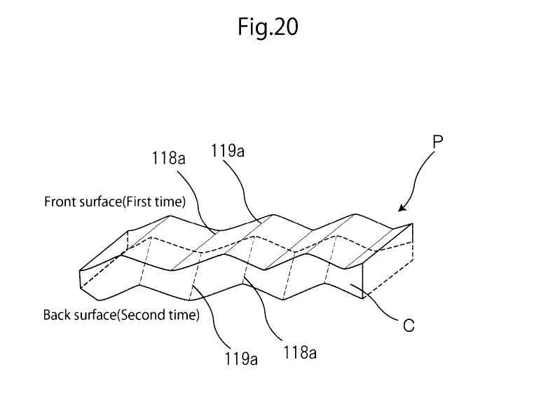

Further, in the case where the foodstuff is cut such that the mountain lines 118 and the valley lines 119 in the first cutting cross those 118, 119 in the second cutting, it is possible to obtain a cut piece P of a further complex shape. FIG. 20 is a perspective view showing a case where loci of the mountain lines 118 and the valley lines 119 in the first cutting are inclined to loci of the mountain lines 118 and the valley lines 119 in the second cutting. Such a cut piece P is obtained by moving the edge 113 in the second cutting in a direction oblique to the stripe mark engraved by the first cutting. For example, such cut pieces P are obtained by repeating operation of cutting in a diagonally right direction and thereafter cutting in a diagonally left direction. By such cutting operation, recessed stripes 118a made by the mountain lines 118 and projected stripes 119a made by the valley lines 119 in the first cutting cross recessed stripes 118a made by the mountain lines 118 and projected stripes 119a made by the valley lines 119 in the second cutting. Accordingly, thickness and shape of a cut piece P vary randomly, and this gives further complex texture. Further, by pulling the cooking tool while shaking, it is possible to cut more randomly.

In such a cut piece P, the angle (inclination) of the stripe mark in the back surface (the second cutting) to the stripe mark in the front surface is, for example, more than or equal to 10 degrees and less than 90 degrees, and more preferably more than or equal to 40 degrees and less than 80.

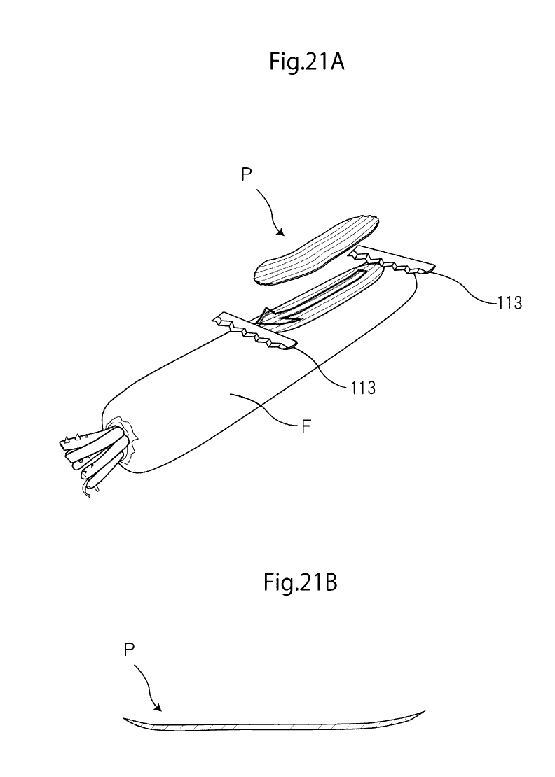

Further, it is possible to form not only a long cut piece P as shown in FIG. 17 but also a short cut piece P. FIG. 21A is an explanatory view for explaining cutting of a short cut piece P for a prescribed length. For example, the length of such a cut piece P is preferably approximately more than or equal to 2 cm and less than 10 cm, and more preferably approximately more than or equal to 3 cm and less than 6 cm. Such a length is easy to eat in the case of, for example, a leaf vegetable or the like, and also a root vegetable of such a length can be eaten stably and palatably. A foodstuff F on the hard side may be cut shorter and thinly, while a soft foodstuff F may be processed longer and thickly. FIG. 21B is a cross-section view of such a cut piece P. The cut piece P shown in the figure, which is formed by cutting the surface through gentle stroking, becomes thinner at both ends, i.e. a position in which the edge 113 is put and a position from which the edge 113 is taken off, while having a certain thickness at the center portion that is cut by sustained force.

By previously making incisions as longitudinal lines and lateral lines in a foodstuff F to form compartments, it is possible to obtain cut pieces P uniform in size even by a long peeling operation.

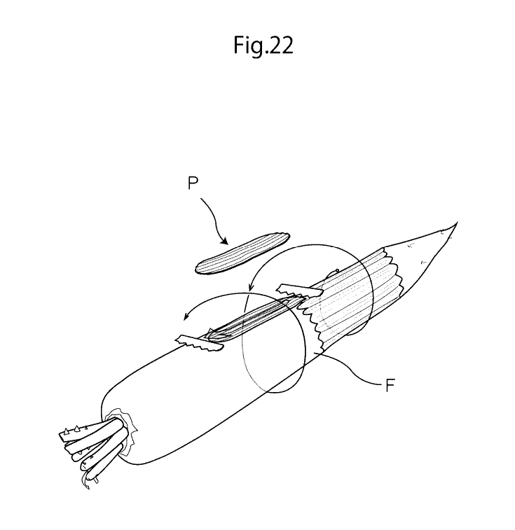

Further, as shown in FIG. 22, it is also possible to keep the width of cut pieces P approximately uniform by repeating cutting of a foodstuff F while rotating the foodstuff F. This figure shows an example where cutting is started at a position near the end of the root and the cut position is shifted upward after a finish of cutting once around the root. After reaching the neck of the root, a similar cutting operation is repeated returning to the position near the end of the root. This makes it possible to have uniform width of cut pieces P even in the case of a rod-like foodstuff F. Particularly, by rotating a foodstuff F while fixing a cut position and by adjusting the degree of rotation and the number of cutting according to the foodstuff F becoming thinner, it is possible to obtain more uniform cut pieces P. Of course, width, length, or stripe mark may be adjusted according to a state of fiber or the like. At this time, when a cut surface is shifted from a flat surface to an angular surface by rotating, non-uniform and varied finish can be obtained.

Here, it is not necessary to rotate while cutting one line at each time. For example, a first line is cut to begin with, and then each line on its right or left is cut. Coming to one of the lines on its right or left, the line in question is cut again, and it is possible to repeat cutting of the line on its right or left again. Thus, it is possible to add some change in width by cutting one line a plurality of times not once and shifting from that line.

In each example of the above-described cooking methods, the edge 113 is used. However, any edge in the above embodiments can be used.

Further, an automated machine can be used so that an edge is slid automatically, a foodstuff F is rotated and moved automatically, or an edge moves automatically in the circumference of a foodstuff F to slide on the foodstuff F. On the contrary, a foodstuff may be slid. Further, a part of operations may be performed by a man, and the other operations may be performed by a machine. For example, a man may supply and move a foodstuff F, and a machine may perform the other operations. Any combination of such operations may be employed.

Further, in each of the above-described cut pieces P, the distance between a stripe engraved by a mountain line 118 and a stripe engrave by an adjacent mountain line 118 (or between a stripe engrave by a valley line 119 and a stripe engrave by an adjacent valley line 119) is more than or equal to 3 mm and less than 30 mm, preferably more than or equal to 3 mm and less than 20 mm, and more preferably more than or equal to 3.5 mm and less than 12 mm similarly to the pitch b.

Further, the thickness of each of the above-described cut pieces P is preferably more than or equal to 0.2 mm and less than 3 mm at the thinnest portion and more than or equal to 0.5 mm and less than 8 mm at the thickest portion.

Further, any foodstuff F can be used as far as the foodstuff F can be cooked by using the present cooking tool. For example, it is possible to mention fresh vegetables, and in detail root vegetables (daikon (Japanese radish), carrot, turnip, and the like), and tubers (potato, sweet potato, yam family (yamaimo (yam), nagaimo (Chinese yam), jinenjo (wild yam), and the like)). As other foodstuffs, it is possible to mention cucumber, tomato, cabbage, zucchini, uri (Oriental melon), niga-uri (balsam apple), celery, pumpkin, stem part of broccoli and cauliflower, fruits (apple, kaki (Japanese persimmon), skin part of watermelon, and the like), cheese, fish, and meat.

The cut pieces P obtained by the present cooking method have the mild frill-like stripe mark in both front and back surfaces, and give a variety of texture owing to changes in thickness, hardness, and the like. Such cut pieces P are well seasoned with seasoning because cell membrane of a foodstuff F is sliced at the time of cutting the foodstuff F. Thus, it is possible to prepare a salad by dressing a lump of frill-like cut pieces P with seasoning such as mayonnaise, other dressing, or the like, or to express texture of pickles by using seasoning containing mainly vinegar. Further, the taste is made even better by adding umami ingredients containing mainly tangle and the like.

Further, edges of the embodiments and their variations can be combined freely.

### REFERENCE SIGNS LIST

10, 20, 30, 40, 50, 60, 70, 90, 100, 110: cooking tool; 11, 21, 31, 71, 81, 91: blade member; 113, 213, 313, 713, 813, 913: edge; 12, 22, 82, 92: cutting part; 13, 23: neck; 14: gripping part; 15: finger insertion hole; 111: escape hole; 112, 712, 812, 912: upper plate; 114, 814: lower plate; 116: rib; 117, 817: foremost portion; 84: drill part; 85: through hole; 86: male screw; 920: step; 96: valley portion; 97: mountain portion; 98: jagging; and 99: clamping portion.

1. A cooking tool comprising:
a cutting part provided with an edge obtained by processing an end of a plate-like member into a zigzag shape,
wherein the edge is formed such that a bend angle of the zigzag shape is an obtuse angle and mountain lines as projected portions and valley lines as recessed portions are inclined to a direction of plate thickness and approximately parallel to one another,
wherein the mountain lines and the valley lines are formed to face a foodstuff side, and
wherein a pitch of the zigzag shape of the edge is more than or equal to 3 mm.

2. The cooking tool of claim 1, wherein:
the bend angle is more than or equal to 90° and less than 175°.

3. The cooking tool of claim 1, wherein:
the cutting part is inclined to a line perpendicular to a center line of a cutting direction or inclined to the center line.

4. The cooking tool of claim 1, wherein:
foremost portions of the edge are each rounded to have a curvature radius of 0.1 mm or more.

5. The cooking tool of claim 1, wherein:
the edge is corrugated.

6. The cooking tool of claim 1, wherein:
the edge is formed in a plate-like blade member curved to be a C-shape.

7. The cooking tool of claim 1, wherein:
the cooking tool is one of: a T-shaped or I-shaped peeler having a gripping part; a slicer having a plate-like slide base; a rotating cutter of a conical shape; a spiral cutter for cutting spirally while being screwed into a foodstuff; and an automatic cutter for cutting a foodstuff while sliding the edge automatically or sliding the foodstuff automatically.

8. A cooking method, comprising:
using the cooking tool of claim 1 to cut a lump-state foodstuff.

9. The cooking method of claim 8, wherein:
cutting is performed such that a new stripe mark approximately overlaps with a stripe mark remaining on a cut surface.

10. The cooking method of claim 8, wherein:
cutting is performed such that a new stripe mark is shifted in a traverse direction with respect to a stripe mark remaining on a cut surface.

11. The cooking method of claim 8, wherein:
cutting is performed such that a new stripe mark crosses a stripe mark remaining on a cut surface.

12. A foodstuff, which is obtained by a cutting work using the cooking tool of claim 1.

13-21. (canceled)
